(19) United States
(12) Patent Application Publication
(10) Pub. No.: US 2008/0296878 A1
(43) Pub. Date: Dec. 4, 2008

(54) Motorcycle Exhaust Pipe Guard and Mounting Bracket

(76) Inventor: John Doug Pruit, Pine, CO (US)

Correspondence Address: Leyendecker & Lemire, LLC, C/O PORTFOLIO IP, P.O. BOX 52050, MINNEAPOLIS, MN, 55402, US

(21) Appl. No.: 11/757,003

(22) Filed: Jun. 1, 2007

(51) Int. Cl. B60R 21/02

(52) U.S. Cl. 280/748

(57) ABSTRACT

A motorcycle exhaust pipe guard for use with a motorcycle having an exhaust pipe running adjacent a passenger's foot peg. The guard includes a planer bar which may be formed to maintain a clearance between the user's foot and the contour of the exhaust pipe. Further, a bracket is provided which uses the existing axis pin of the foot peg for mounting the guard to the foot peg bracket at a position between the foot peg and the motorcycle, and at an elevation above the foot peg.

### FIELD OF THE INVENTION

The present invention relates generally to motorcycle components and accessories.

### BACKGROUND

Motorcycles having gasoline engines generally have engines that are located at a forward position on the motorcycle underneath the gas tank, which is typically located to the front of the vehicle's seat. Most motorcycles can transport two people: an operator and a passenger. A pair of foot pegs or floor boards are typically provided with one peg or floorboard on each side of the motorcycle for the operator, and another pair of foot pegs with one peg on each side of the motorcycle that usually can fold upwardly when not in use are provided for use by an occasional passenger. On most motorcycles, 1-4 exhaust pipes extend along one or both sides of the motorcycle to the rear thereof. Typically, on at least one side of the motorcycle a folding passenger foot peg is located just to the outside of one or two exhaust pipes.

Accordingly, given the foregoing and when a motorcycle is carrying a passenger, the passenger places his/her feet on foot pegs that are located in close proximity to the exhaust pipe and muffler. The exhaust pipe and muffler become extremely hot during the use of the motorcycle, and often times a passenger unintentionally positions his/her foot against this exhaust pipe or muffler causing the passenger's clothing, footwear or even legs and ankles to be burned. Generally, an exhaust pipe extends along the inner side of the foot peg and below this foot peg. However in the models of many newer motorcycles, the exhaust pipes extend both above and below the passenger's foot peg. This makes the mounting of prior art foot peg heat shields, many of which are designed for the primary riders foot peg and/or foot platform, to the passenger foot peg(s) difficult if not impossible.

In the older standard configuration of foot pegs, where the foot peg was above the exhaust pipe, there was plenty of room to mount a protector via a clamping type of mount on the foot peg mounting arm. However, with the new above and below the foot peg exhaust pipe configuration, the available space on the foot peg mounting arm is hidden or covered up by an exhaust pipe extending towards the rear of the motorcycle above the passenger foot peg. In fact, the only part of the foot peg mounting bracket that protrudes between upper and lower exhaust pipes are the two parallel receiver arms on the end of the foot peg mounting bracket which pivotally receives and holds the peg so the peg can be swung from a generally horizontal orientation into a generally vertical orientation against the side of the motorcycle when not in use by a passenger.

Heat shields for use with motorcycles are known especially those intended for use with the foot pegs of a primary rider. For example, U.S. Pat. No. 6,179,313 by Christensen shows a motorcycle exhaust pipe heat shield having a planar configuration that is mounted between a primary rider footrest and the exhaust pipe. Christensen uses a two arm clamp configuration to mount his shield to the foot peg mounting arm. Use of this design on a passenger foot peg of some newer motorcycles with the aforementioned exhaust pipe configurations would require the two arm clamp to be wrapped around the outer end of the foot peg mounting arm (i.e. the parallel receiver arms) which is the only available space. Clamping across the end of the mounting arm covers the pivot point of the foot peg and prevents the foot peg from being pivoted against the motorcycle for storage purposes or for the purpose of being out of the way of the operator as he/she pushes the motorcycle using his/her legs.

Another example is U.S. Pat. No. 6,626,448 by Miles in which he differentiates his design from Christensen's by the fact that his shield is made of a cylindrical elongated rod instead of planar design. This design provides a bent portion with the option to go around the back of a rider's heel to keep it from sliding off of the peg. However, Miles uses the same mounting solution as Christensen and in doing so; he introduces the same limitations to his design.

Another example is U.S. Pat. No. 7,017,932 B1 which is a continuation-in-part of U.S. Pat. No. 6,626,448 also issued to Miles. In this patent, Miles broadens his original claims using the rod shield and introduces an additional design that does not impede the foot peg from being collapsed when the shield is installed and mounted at the outer end of the foot peg mounting arm. However, Mile's new design is made from two dependant parts where the cylindrical rod is mounted into a cylindrical hole of the mounting bracket. There is a small setscrew that is used to hold this rod in position. Because of the extremely limited contact area of this set screw onto the surface of the rod, there are models of motorcycles where the vibration of the motorcycle itself can cause this small set screw to loosen up thereby letting the rod rotate from its mounted position or even vibrate out of the receiving hole in the mounting arm completely while the motorcycle is in motion. A further limitation to this design is the fact that the bent rod shield is held always parallel to the axis pin joining the foot peg to the foot peg mounting arm. In many motorcycle designs, this axis pin is not parallel to the exhaust pipe. Therefore, when mounting a guard which is limited to being parallel with the axis pin, the guard is not parallel to the exhaust pipe and does not provide even protection along the entire side of the user's foot and the exhaust pipe.

### DESCRIPTION OF DRAWINGS

In order that the invention may be clearly understood and readily carried into effect, a preferred embodiment of the invention will now be described, by the way of example only, with reference to the accompanying drawings wherein:

FIG. 1 is a prior art rear elevational view of a fragment of a conventional motorcycle with the conventional motorcycle passenger's foot peg having an exhaust pipe above and below the foot peg;

FIG. 2 is a prior art front elevational view of a fragment of a conventional motorcycle showing the passenger foot peg collapsed in its upright storage position;

FIG. 3 is a front elevational plan view a guard according to an embodiment of the present invention; and

FIG. 4 is a side plan view of the guard according to an embodiment of the present invention as also illustrated in FIG. 3.

FIG. 5 is a side plan view of a guard according to an embodiment of the present invention;

FIG. 6 is a side plan view of a guard according to an embodiment of the present invention;

FIG. 7 is a side plan view of a guard according to an embodiment of the present invention;

FIG. 8 is an elevational view of the guard of FIG. 3 placed against the side of the foot peg mounting arm of the motorcycle prior to being secured in place according to an embodiment of the present invention;

FIG. 9 is the top view of the guard of FIG. 3 installed on a foot peg mounting arm according to an embodiment of the present invention;

FIG. 10 is the top elevational view of the guard of FIG. 6 partially mounted to the foot peg mounting arm of the motorcycle according to an embodiment of the present invention;

FIG. 11 is the top view of the guard of FIG. 6 installed on the foot peg mounting arm of the motorcycle according to an embodiment of the present invention;

FIG. 12 is an isometric view of a mounting bracket of a guard assembly showing the mounting bracket placed against the mounting arm of a foot peg according to an embodiment of the present invention;

FIG. 13 is an exploded view of a guard assembly utilizing the mounting bracket of FIG. 12 according to an embodiment of the present invention;

FIG. 14 is an illustration of a guard portion of a guard assembly according to an embodiment of the present invention.

FIG. 15 is a rear elevational view of a fragment of a conventional motorcycle with the conventional motorcycle passenger's foot peg having an exhaust pipe above and below the foot peg with a guard assembly incorporating the mounting bracket of FIG. 12 and the guard portion of FIG. 14 installed thereon according to an embodiment of the present invention;

FIG. 16 is a partial side view of an mounting bracket of a guard assembly configured to mount the guard portion at multiple angles in relationship to the axis pin of the foot peg according an embodiment of the present invention; and

FIGS. 17-19 are front elevational views of various guard assemblies, each capable of having the guard portion mounted at multiple angles in relationship to the axis pin of the foot peg according to embodiments of the present invention;

FIG. 20 is an illustration of a blank of plate material from which a single piece guard, such as illustrated in FIG. 3 can be made according to an embodiment of the present invention.

### DESCRIPTION OF A PREFERRED EMBODIMENT

Embodiments of the present invention include a motorcycle exhaust pipe guard assembly comprising a guard portion, a mounting bracket and associated hardware for typical use on a passenger foot peg on motorcycles having an exhaust pipe running adjacent the passenger's foot peg. Variations of the guard comprise one or more planer sections, which help maintain a clearance between the user's foot including the heel and the contour of the exhaust pipe and larger diameter muffler. Further in certain embodiments, a mounting bracket is provided for mounting the guard portion (also referred to as a shield herein) to the foot peg at a position between the foot peg and the motorcycle, and at an elevation above the foot peg and at multiple angles in relationship to an axis pin of the pivotally collapsible passenger's foot peg in a manner that does not inhibit the pivotally movement of the passenger's foot peg.

In variations, both the guard portion and the mounting bracket are fabricated from sheet and/or plate stock that is subsequently bent and/or formed into their final configurations. The plate for the guard portion is in certain variations formed to follow the contour of the exhaust pipe that it is placed in front of. For instance, wherein the exhaust transitions from a relatively small diameter pipe to a larger diameter muffler, the guard may be configured accordingly to maintain a generally uniform distance from the exhaust system along its entire length. Additionally or alternatively, the guard can be curved to correspond to the curvature of the cylindrical exhaust pipes and/or muffler. The contouring helps maintain the guard a sufficient distance from the exhaust system while potentially improving the aesthetic appeal of the guard.

Other embodiments of the present invention comprise a single piece guard fabricated from a planar piece of sheet stock that can be mounted to a passenger foot peg bracket and permit full pivotal movement of the foot peg between stowed and deployed positions. In any of the various embodiments and variations, the various components of the guard assembly can be appropriately finished to blend in with or complement the motorcycle on which the components are mounted. For instance, the guards can be chromed, blued, painted, anodized, and/or coated.

### Terminology

The term “or” as used in this specification and the appended claims is not meant to be exclusive rather the term is inclusive meaning “either or both”. References in the specification to “one embodiment”, “an embodiment”, “a preferred embodiment”, “an alternative embodiment”, “one variation”, “a variations” and similar phrases mean that a particular feature, structure, or characteristic described in connection with the embodiment is included in at least an embodiment of the invention. The appearance of the phrase “in one embodiment” in various places in the specification are all not necessarily meant to refer to the same embodiment.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” or “generally” as used herein unless otherwise indicated means a margin of ±20%. Also, as applicable, the term “substantially” as used herein unless otherwise indicated means a margin of ±10%. It is to be appreciated that not all uses of the above terms are quantifiable such that the referenced ranges can be applied.

### Single Piece Foot Peg Guards According to Embodiments

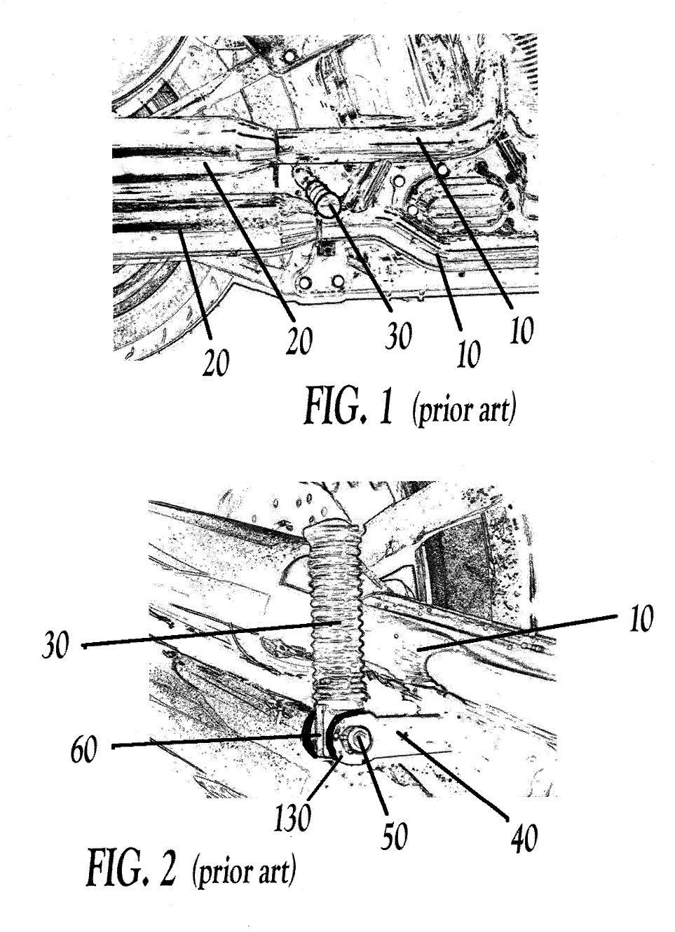

Prior art FIGS. 1 & 2 illustrate the exhaust pipe and a passenger's foot peg configuration present on many motorcycles, especially newer models. As shown in FIG. 1, upper and lower exhaust pipes 10 are connected to larger diameter mufflers 20. A passenger foot peg 30 and associated mounting hardware extends outwardly of the motorcycle's frame in between the upper and lower exhaust pipe and muffler combinations. As shown in FIG. 2, the foot peg 30 is illustrated in its stored or stowed position. The foot peg mounting hardware includes a mounting bracket 40 that is secured to the motorcycle's frame. The bracket 40 is formed into two spaced and parallel mounting arms 130 at its distal end in which a proximal end 60 of a foot peg is received. The foot peg 30 is pivotally secured to the foot peg mounting bracket by way of a cylindrical axis pin 50 that passes through openings in the mounting arms 130 and the proximal end of the foot peg. The axis pin can comprise an at least partially threaded bolt and is held in place by way of an associated nut. Alternatively, the pin may not be threaded but rather have one flanged end and an opposing second end including a slot adapted to receive a c-clip. Other variations of the pin may utilize a cotter pin to secure the pin in place. The foot peg is pivotal between the generally vertically upright stowed position and a generally horizontal deployed position.

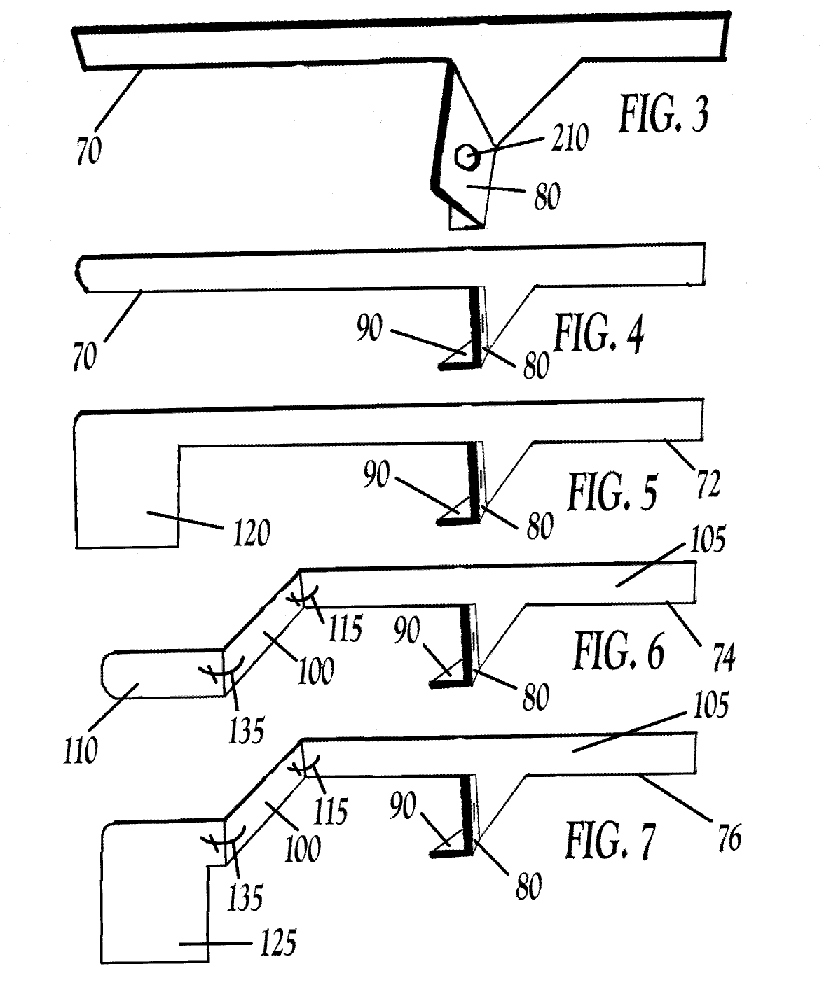

Embodiments of single piece guards are shown in FIGS. 3-7. FIG. 3 shows one variation of the guard 70 with the cylindrical hole 210 in an integral mounting arm 80. FIG. 4 shows an integral lip 90 on the bottom of mounting arm 80 which provides means to limit the rotation of the guard around the axis pin 50 shown in FIGS. 2, 9-11 by bracing against the bottom of one of the foot peg mounting arms 130 when installed.

FIG. 20 is an illustration of a blank 400 of plate material from which a single piece guard 70, such as illustrated in FIG. 3 can be fabricated. The plate or sheet is typically comprised of a steel alloy but may also comprise other metallic materials, such as aluminum. The blank can be made using any suitable means, such as machining, but in at least one variation the blank is stamped from sheet stock.

The dashed lines 405 & 410 indicate lines of bending along which the blank 400 is bent to create the guard's final form. Creases may, but need not, be formed in the blank during the stamping operation to facilitate easier bending in a subsequent operation. The cylindrical hole 210 in the mounting section can be formed during the stamping operation or in a subsequent operation, such as by drilling.

The blank is typically bent into final form using a brake. For instance, the mounting portion 80 is bent outwardly ninety degrees relative to the downwardly extending flange portion 415 of the guard portion. The integral lip 90 is bent ninety degrees inwardly relative to the mounting portion. In some variations, the main body of the guard may be curved along a longitudinal axis of the guard to correspond to the curvature of the exhaust pipe and/or the muffler.

Once the guard is fully formed, it is prepared for final finish. For instance, the unit may be tumbled in abrasive particles to deburr and break the rough edges. The unit may be cleaned and as necessary acid etched to prepare it to receive its final finish, such as chrome.

It is to be appreciated that substantially similar manufacturing processes can be utilized to produce the variations of the single piece guard illustrated in FIGS. 5-7 as further described below. Further, variations are contemplated wherein the single piece guard is fabricated into its final form in a single operation, such as by casting of a metallic guard or injection molding of a reinforced or unreinforced polymeric material. Variations are also contemplated wherein the guard is molded of a carbon fiber laminate.

FIG. 5 shows another embodiment of a single piece guard 72 having a single integral mounting arm 80. This embodiment includes a downwardly extending portion of the guard 120 which projects below the foot peg so as to guard a passenger's foot from the lower muffler 20 which runs below the passenger's foot peg as shown in FIG. 1.

FIG. 6 shows yet another embodiment of a single piece guard 74 with a single integrated mounting arm 80. This embodiment includes a mid portion forming a second plane 100 which intersects with a first plane 105 of the main body of the guard 74 at an angle 115 typically between about 90-160 degrees and a third aft plane 110 which is generally parallel to the first plane of the guard and intersects with the second plane at an obtuse angle 135 typically of about 200-270 degrees. Also shown is the integral lip 90 on the bottom of mounting bracket 80 which provides means to limit the rotation around the axis pin 50 shown in FIGS. 2, 9-11 by bracing against the bottom of the foot peg mounting arm 130 shown in FIGS. 2, 9-11 when the guard is installed.

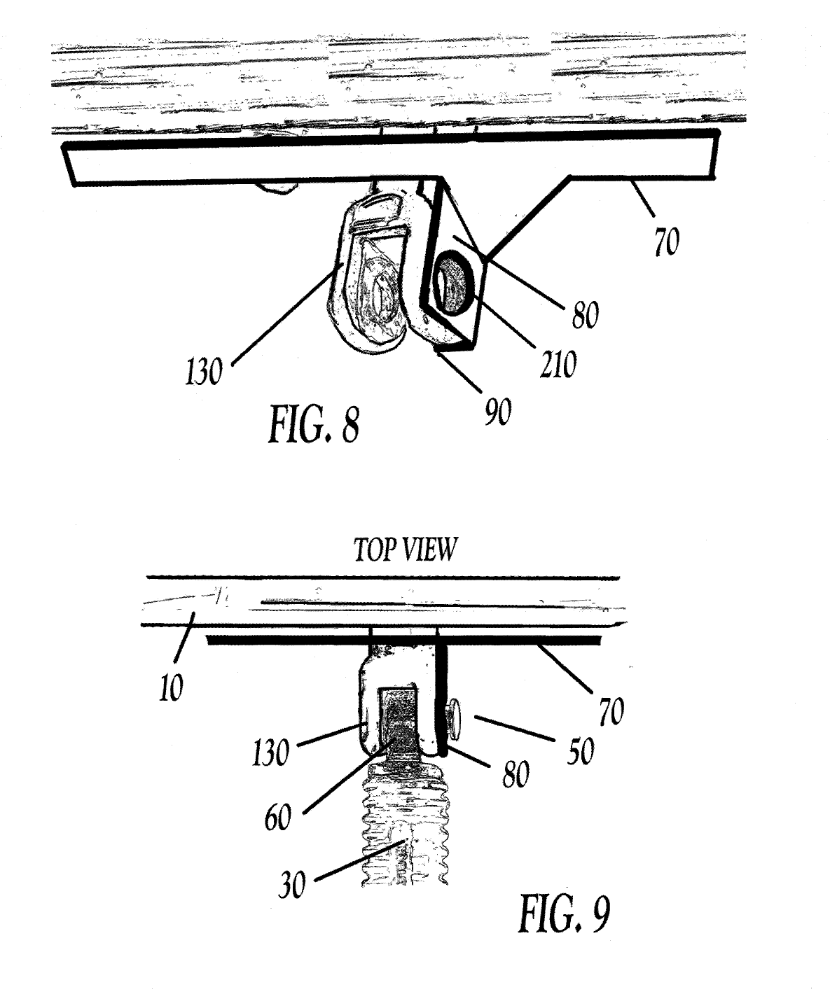

FIG. 7 shows one more embodiment of a single piece guard 76 with a single integrated mounting bracket 80. This embodiment includes a mid portion forming a second plane 100 which intersects with a first plane 105 of the main body of the guard 74 at an angle 115 typically between about 90-160 degrees and a third aft plane 110 which is generally parallel to the first plane of the guard and intersects with the second plane at an obtuse angle 135 typically of about 200-270 degrees.

The portion comprising the third aft plane also extends downwardly to project below the foot peg so as to guard a passenger's foot from the lower muffler 20 which runs below the passenger's foot peg as best shown in FIG. 1. Also shown in FIG. 7 is the integral lip 90 on the bottom of mounting arm 80 which provides means to limit the rotation around the axis pin 5 shown in FIGS. 2, 9-11 by bracing against the bottom of the foot peg mounting arm 13 shown in FIGS. 2, 9-11 when the guard is installed.

FIG. 8 shows an embodiment of the single piece guard 70 with the integral mounting bracket 80 in the installation position adjoining the arm of the foot peg mounting arm 130 and having the integral lip 90 braced against the bottom of foot peg mounting arm 130. The guard mounting bracket 80 is shown with cylindrical hole 210 extending therethrough. FIG. 9 shows the top view of the single piece guard 70 as it is installed next to exhaust pipe 10 using the axis pin 50 which holds the foot peg's mounting post 60 between the foot peg mounting arms 130.

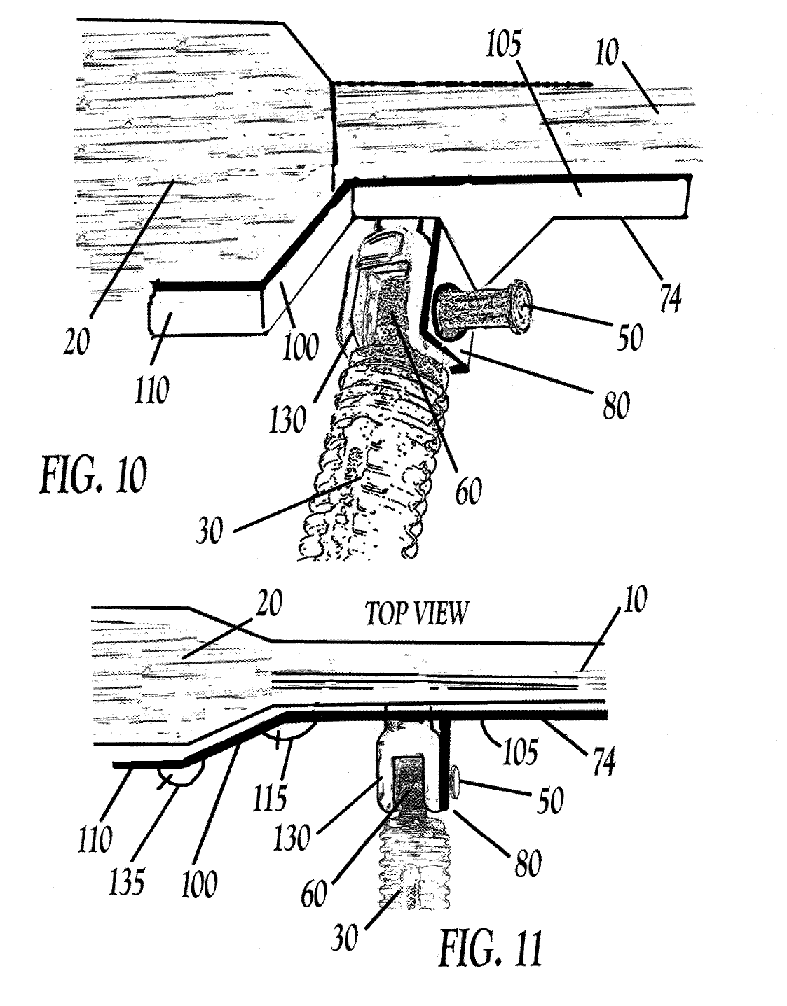

FIG. 10 shows the single piece guard embodiment of FIG. 6 in the process of being mounted to the foot peg mounting arm of a motorcycle. This embodiment includes a mid portion forming a second plane 100 which intersects with a first plane 105 of the main body of the guard 74 at an angle 115 typically between about 90-160 degrees and a third aft plane 110 which is generally parallel to the first plane of the guard and intersects with the second plane at an obtuse angle 135 typically of about 200-270 degrees. The first plane of guard 74 generally conforms to the narrow exhaust pipe 10. The second and third planes 100 and 110 conform to the transition from the small exhaust pipe to the larger diameter muffler and larger diameter the muffler 20. The guard is held in place by the axis pin 50 which allows the foot peg post 60 of foot peg 30 to pivot in an upward direction between the two mounting arms 130 of the foot peg mount 40. It is to be appreciated that the other single piece guard embodiments described above also mount to the foot peg mounting arm in a substantially similar manner.

FIG. 11 shows the top view the third embodiment of guard 74 with an integral mounting arm 80 as shown in FIG. 10. This embodiment includes a mid portion forming a second plane 100 which intersects with a first plane 105 of the main body of the guard 74 at an angle 115 typically between about 90-160 degrees and a third aft plane 110 which is generally parallel to the first plane of the guard and intersects with the second plane at an obtuse angle 135 typically of about 200-270 degrees. The second and third planes 100 and 110 conform to the transition from the small exhaust pipe to the larger diameter muffler and larger diameter the muffler 20. The guard is held in place by the axis pin 50 which allows the foot peg post 60 of foot peg 30 to pivot in an upward direction between the two mounting arms 130 of the foot peg mount.

### Two Piece Foot Peg Guards According to Embodiments

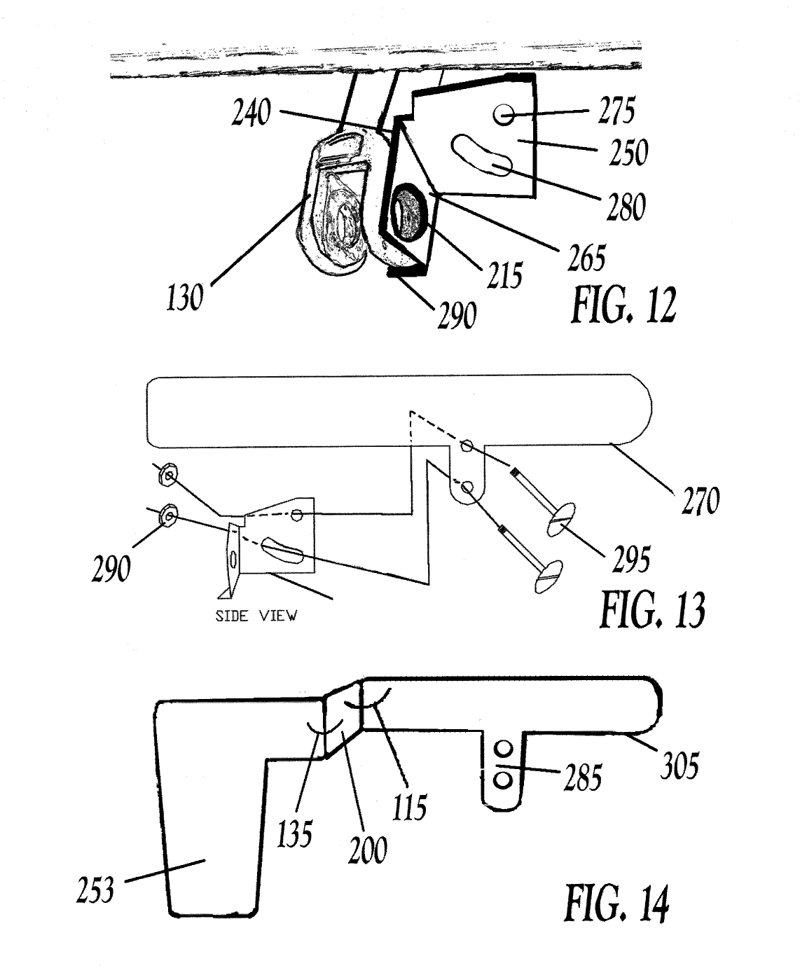

FIGS. 12-19 illustrate several embodiments and associated components of a two piece foot guard assemblies that comprises a guard or shield portion and a mounting bracket portion along with associated mounting hardware, such as threaded fasteners and nuts. In each embodiment, the mounting bracket portion mounts fixedly and securely to a passenger foot peg mounting arm 130 of a motorcycle, typically by way of an axis pin 50. The guard/shield portion is secured to the mounting bracket typically with fasteners; however, the relative angle of the guard portion and the mounting bracket can be varied to permit a longitudinal axis of the guard portion to be aligned in a substantially parallel relationship with the exhaust pipe(s) 10 and/or muffler(s) 20 especially when the mounting arms 130 of the foot peg mounting arm 40 are not orthogonally orientated relative to the exhaust pipe and muffler. Advantageously, the various two piece foot peg guards can fully protect a passenger's foot no matter the angle of the mounting arms relative to the exhaust pipe and/or muffler in contrast to prior art foot peg and foot platform guards in which the longitudinal axis of the guard usually must be orientated parallel to the axis pin 50.

FIG. 12 shows a mounting bracket 240 used in certain embodiments. This mounting bracket 240 is typically formed from sheet material that is configured to form first and second planar portions 250 and 265 that form about a ninety degree angle at their intersection. The second planar portion 265 of the mounting bracket 240 has a cylindrical hole 215 for receiving an axis pin 50 to secure bracket to the outside of foot peg mounting arm 130. The second planar portion 265 also has integral lip 290 that braces against the bottom of foot peg mounting bracket arm 130 when the bracket is installed. The first planar portion 250 has a cylindrical hole 275 for receiving a fastener 295 about which the guard portion 270 can be pivoted for angular adjustment thereof. The first planar portion also includes an arcuate slot 280, which has a center of rotation about the center of the cylindrical hole 275. The arcuate slot is configured to receive a second fastener 295 therein used for locking the guard portion 270 in place against the mounting bracket once the desired angular orientation has determined.

FIG. 13 is an exploded view of a two piece guard assembly including the guard portion 270, the mounting bracket portion 240, two threaded fasteners 295 and associated lock nuts 290. A protrusion 285 extends downwardly from the main body of the guard. The protrusion includes two circular openings extending therethrough to receive the threaded fasteners utilized to secure the guard portion to the mounting bracket portion at a desired angular orientation.

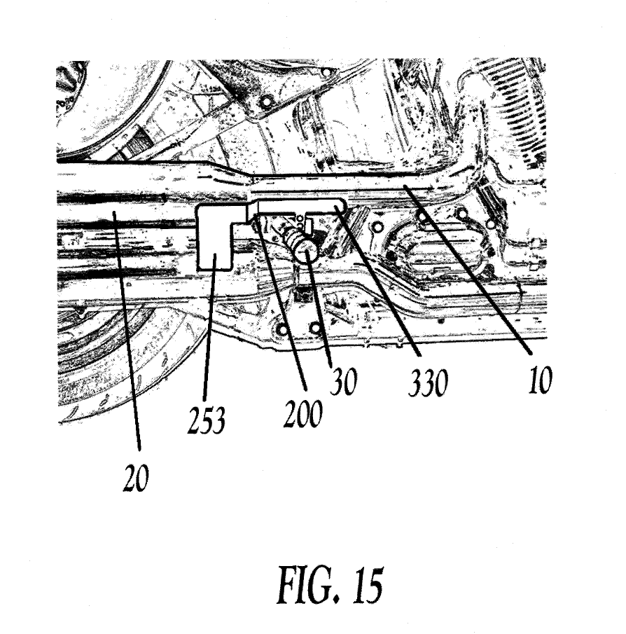

FIG. 14 shows a guard portion 305 with a protrusion 285 substantially similar to the protrusion shown in the guard portion 270 of FIG. 13. Accordingly, this guard portion can be utilized with the mounting bracket 265 that is illustrated in FIGS. 12 & 13. This embodiment also includes a mid portion forming a second plane 200 which intersects with a first plane 245 of the main body of the guard 305 at an acute angle 115 typically between about 10-45 degrees and a third aft plane 253 which is generally parallel to the first plane of the guard and intersects with the second plane at an obtuse angle 135. The portion comprising the third aft plane also extends downwardly to project below the foot peg so as to guard a passenger's foot from the lower muffler 20 which runs below the passenger's foot peg as best shown in FIG. 1.

FIG. 15 shows an elevational view of a guard assembly including the guard portion 305 of FIG. 14 installed on a motorcycle. This embodiment also includes a mid portion forming a second plane 200 which intersects with a first plane 245 of the main body of the guard 305 at an acute angle 115 typically between about 10-45 degrees and a third aft plane 253 which is generally parallel to the first plane of the guard and intersects with the second plane at an obtuse angle 135. The first plane 245 of guard 305 conforms to the narrow exhaust pipe 10. The planes 200 and 250 conform to the larger diameter of the muffler 20 including the portion wherein the muffler diameter tapers to the diameter of the exhaust pipe.

FIG. 16 is a side plan view that shows another manner of mount the protrusion 285 of a guard/shield portion at one of various angular orientations in relation to a corresponding mounting bracket 255. The mounting bracket of this variation is generally similar to the mounting bracket 240 of FIG. 12 except the first planar portion includes a single, typically centered, opening 245 extending therethrough instead of the circular opening 275 and arcuate slot 280 of the FIG. 12 mounting bracket 240. An arcuate set of teeth 260A that are fixedly attached to the surface of the first planer portion surround the opening 245. A similar set of arcuate teeth 260B surround a single opening on the guard portion's protrusion 285 and are affixed thereto. The teeth from each set mesh with each other and act to hold the guard portion in a fixed angular orientation relative to the mounting bracket when associated fastener 295 is placed through the respective openings and tightened in place via a lock nut 290.

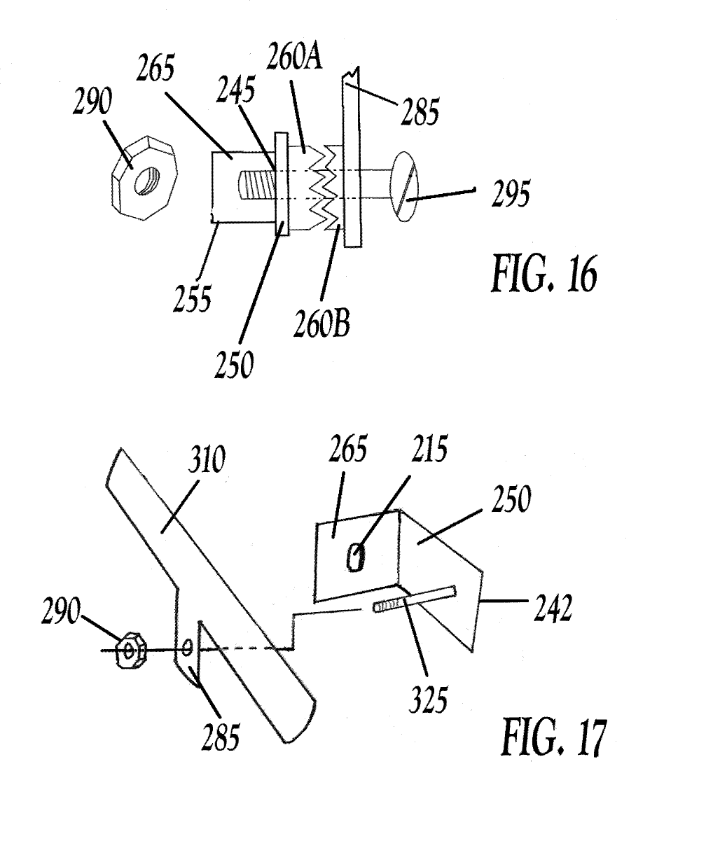

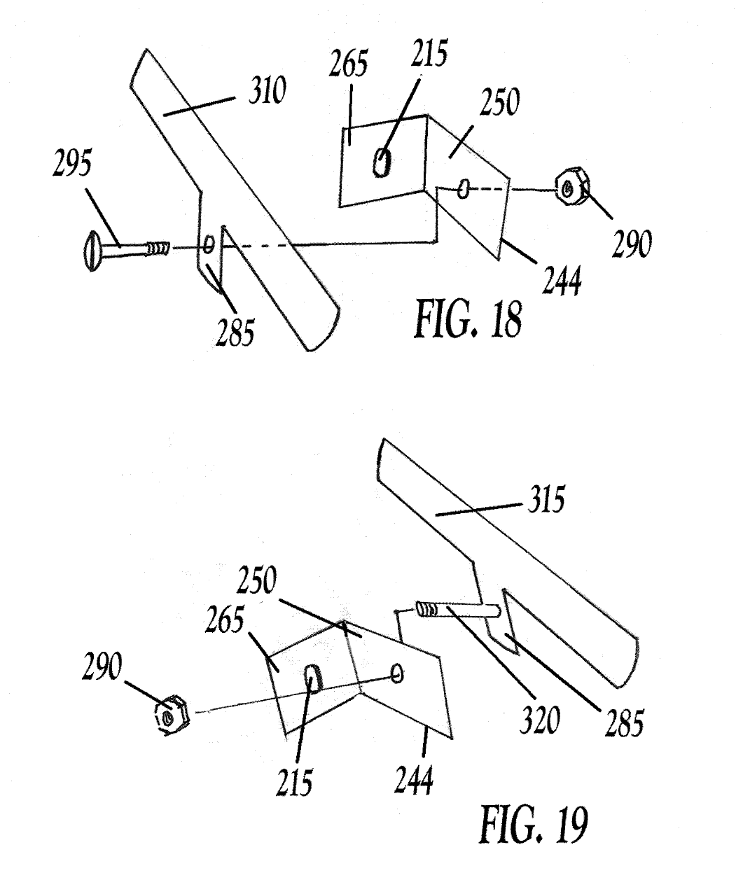

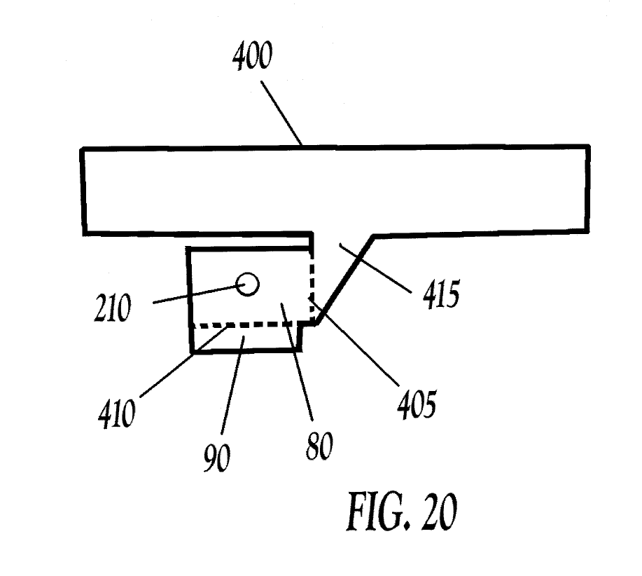

FIGS. 17-19 also illustrate various manners of mounting a guard/shield portion to a mounting bracket portion such that the angle between the portions can be adjusted to account for differing orientations between the mounting arms 130 of the passenger foot peg and the exhaust pipe(s) 10 and/or muffler(s) 20. The mounting bracket 242 of FIG. 17 comprises an integral post 329 that passes through the mounting leg of guard portion 310 and is secured by lock nut 290. The mounting bracket of FIG. 18 includes an opening on planar portion 250 which receives a threaded fastener 295 that also passes through an opening in the guard portion's protrusion 285. The fastener is tightened and held securely in place by way of a lock nut 290. In FIG. 19, an integral threaded post 320 is provided on the protrusion 285 of the guard portion that passes through an opening on the first planar portion 250 of the mounting bracket 244. The post is assembly is secured together and tightened by way of a lock nut 290. It is appreciated that in any of these variations, lock washers, serrated washers or other suitable means to hold the portions fixed relative to each other may be utilized as would be obvious to one of ordinary skill in the art given the benefit of this disclosure. Further, the foregoing merely illustrates a number of ways to secure a mounting bracket portion to a guard/shield portion wherein the relative angles between the portions can be adjusted within a suitable range. Other ways of accomplishing the same result are contemplated and unless otherwise indicated are considered to be within the scope of one or more of the appended claims.

### Other Embodiments and Variations

The various embodiments and variations thereof illustrated in the accompanying figures and/or described above are merely exemplary and are not intended to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention. For instance, various features of the various guards, guard portions and mounting bracket portions can be interchanged as is practical and suitable. Further, the shield portion of the guard may comprise a rod, tube or even a billet instead of a plate or sheet material.

I claim:

1. An exhaust system guard mountable on a motorcycle having a foot peg, an end portion of the foot peg being received between two spaced-apart mounting arms of a mounting bracket of the motorcycle and pivotally secured therein by an axis pin, the exhaust system guard being adapted to mount against only one mounting arm of the two spaced apart mounting arms by receiving a single end of the axis pin through an axis pin opening in the exhaust system guard.

2. The exhaust system guard of claim 1 comprising: a generally planar mounting arm portion, the mounting arm portion adapted to mount substantially flush against an outside surface of the one mounting arm, the mounting arm portion including the axis pin opening extending therethrough.

3. The exhaust system guard of claim 2 further comprising: a heat shield portion, an outside surface of a first generally planar section of the heat shield substantially adjacent to the mounting arm portion being substantially perpendicular to an outside surface of the mounting arm portion.

4. The exhaust guard of claim 3, wherein the heat shield portion and the mounting arm portion are integral and unitary.

5. The exhaust guard of claim 3, wherein the heat shield portion and the mounting arm portion comprise distinct pieces.

6. The exhaust guard of claim 5, wherein the heat shield portion is pivotally secured to the mounting arm portion and is adapted to be secured in a plurality of angular positions relative to the mounting arm portion.

7. The exhaust guard of claim 2 wherein a lip flange extends from an edge of the mounting arm portion substantially perpendicularly to the mounting arm portion, the lip flange adapted to rest against an edge of the one mounting arm when the exhaust guard is installed on the motorcycle.

8. The exhaust guard of claim 3 wherein the heat shield comprises the first generally planar section, a second generally planar section and a third generally planar section, all three generally planar sections comprising parts of an integral piece, the mounting arm portion extending generally downwardly from the first generally planar section, the second generally planar section intersecting with the first generally planar section at a first end and forming about a 90-160 degree angle therebetween, the third generally planer section intersecting with a second end of the second generally planar section, the second end being opposite the first end, the third generally planar section being generally parallel with the first generally planar section.

9. The exhaust guard of claim 6 further comprising:
a first fastener; and
a second fastener;
wherein (i) the mounting arm portion further includes a generally planar heat shield coupling portion, the heat shield mounting portion including a pivot fastener opening adapted to receive the first fastener therethrough and an arcuate slot having a radius of curvature about a center axis of the pivot fastener opening adapted to receive the second fastener therethrough, and (ii) the heat shield portion includes a downwardly extending leg having to heat shield openings therethrough, the heat shield openings being adapted to receive the first and second fasteners to couple the mounting arm portion with the heat shield portion.

10. The exhaust guard of claim 4 wherein the exhaust guard is fabricated from a single piece of sheet metal.

11. The exhaust guard of claim 8, wherein the third generally planer section includes a downwardly extending appendage having a bottom edge located below a bottom edge of the mounting arm portion.

12. A combination comprising:
a motorcycle having at least one exhaust system extending generally to an aft end of the motorcycle, the motorcycle further including a foot peg assembly having (i) a foot peg, (ii) a mounting bracket with two spaced-apart mounting arms wherein an end of the foot peg is received therebetween, the mounting bracket being secured to the remainder of the motorcycle generally below the at least one exhaust system, (iii) an axis pin pivotally securing the foot peg between the two spaced apart mounting arms; and
an exhaust system guard, the exhaust system guard being mounted against only one mounting arm of the two spaced apart mounting arms by receiving a single end of the axis pin through an axis pin opening in the exhaust system guard.

13. The combination of claim 12, wherein the foot peg assembly is located in a position on the motorcycle intended for use by a passenger of the motorcycle.

14. The combination of claim 12, wherein: (a) the exhaust system guard includes a heat shield portion having a longitudinal axis; (b) the axis pin is not parallel with a muffler of the at least one exhaust system; and (c) the longitudinal axis is substantially parallel with the muffler.

15. The combination of claim 12, wherein the exhaust system guard includes: (1) a heat shield portion having a longitudinal axis; and (2) a mounting arm portion adapted to be mounted against the one mounting arm, the heat shield portion being pivotally coupled to the mounting arm portion wherein the angle of the longitudinal axis relative to a muffler or tailpipe of the exhaust system is adjustable.

16. A motorcycle including: (i) an exhaust pipe and muffler combination extending in a fore to aft direction along at least one side of the motorcycle; (ii) a foot peg assembly with (1) a mounting bracket extending generally laterally outwardly of the motorcycle adjacent and below one of the exhaust pipe and muffler, and (2) a foot peg pivotally coupled to the mounting bracket; and (iii) an exhaust guard including a mounting bracket portion coupled to the mounting bracket and a heat shield portion coupled to the mounting bracket portion and adapted to permit angular adjustment of the heat shield portion relative to the mounting bracket portion.

17. The motorcycle of claim 16, wherein (a) the foot peg is pivotally coupled to the mounting bracket by way of a pin, the longitudinal axis of the pin not being parallel with a portion of the muffler or exhaust pipe extending above the mounting bracket, and (b) a longitudinal axis of the heat shield portion is substantially parallel to the muffler and/or exhaust pipe over the length of the heat shield portion.

18. The motorcycle of claim 16 wherein the foot peg assembly is a passenger foot peg assembly and not a foot peg assembly intended for use by a primary rider.

19. The motorcycle of claim 16 wherein (a) the exhaust pipe has a first diameter and the muffler has a second diameter, the first diameter being smaller than the second diameter, (b) the transition between the exhaust pipe and the muffler comprises a frustoconical section, and (c) heat shield portion extends longitudinally from a location in front of the exhaust pipe across the frustoconical section and terminating at a location in front of the muffler with the heat shield portion maintaining generally a similar lateral distance from the respective portions of the exhaust pipe, the frustoconical section and the muffler section over substantially the entire length of the heat shield portion.

20. The motorcycle of claim 16, wherein the exhaust guard is mounted to the mounting bracket by way of a pin, the pin also pivotally securing the foot peg to the mounting bracket.
